(19) United States
(12) Patent Application Publication
(10) Pub. No.: US 2018/0146021 A1
(43) Pub. Date: May 24, 2018

(54) Media Stream Bookmarking

(71) Applicant: ARRIS Enterprises LLC, Suwanee, GA (US)

(72) Inventors: Xiaofeng Cai, Lexington, MA (US); Michael Rosenblum, Arlington, MA (US)

(21) Appl. No.: 15/357,627

(22) Filed: Nov. 21, 2016

(51) Int. Cl. H04L 29/06; H04L 29/08

(52) U.S. Cl. CPC H04L 65/604; H04L 67/14; H04L 65/607

(57) ABSTRACT

Methods, systems, and computer readable media may be operable to facilitate the capture of a segment of a media stream. A media segment may be captured from a media stream in response to a received media segment capture request. A media segment type may be determined from a default setting or from a received user command identifying the desired media segment type. Based on the determined media segment type, the captured media segment may be converted to a media format associated with the media segment type, and the converted media segment may be stored or output to an external sever or client device. Information associated with the media segment or media stream from which the media segment is captured may be retrieved from the media stream or user input and may be added to the converted media segment as metadata.

### TECHNICAL FIELD

This disclosure relates to the capture of media segments.

### BACKGROUND

Multimedia devices such as multimedia gateways, set-top boxes (STBs), and others may be used by a subscriber to receive, process, and output various types of media (e.g., audio content, video content, audio/video content, etc.). Multimedia devices may be configured to record and store pieces of content that are received at the device (e.g., DVR (digital video recorder) functionality). In some instances, a user might only be interested in one or more segments of a program (e.g., highlights, favorite scenes or images, information captures, etc.), and the user might desire that these one or more segments be permanently, or for at least an extended period of time, saved at a DVR device or other application. The one or more segments may be only a fraction of the total length of the associated program. Moreover, using current DVR interfaces, playback of desired content segments is hampered as it requires searching through the rest of the piece of content using trickplay functions (e.g., fast-forward, rewind, skip, etc.) to get to a desired location within the content.

With currently deployed DVR and set-top box (STB) technology, in order for a user to record a short video segment, the consumer typically has to be next to the DVR device or STB during a live transmission (or retransmission, if offered) and needs to press ‘Record’ and ‘Stop’ buttons located on the DVR device or STB precisely at the targeted start and stop points of the desired video segment. Besides the issue of requiring the user to be present to manually perform the recording, the user is further expected to have prior knowledge that an upcoming segment of the live content is going to be a segment that the user will want saved as an individual segment, which is problematic during a first viewing of the content.

Currently, DVR devices do not permit a user to create, organize, playback, or access individual segments of content that are of interest to the user. Therefore, a need exists for methods and systems operable to facilitate an efficient capture of media segments.

### BRIEF DESCRIPTION OF THE DRAWINGS

FIG. 1 is a block diagram illustrating an example network environment operable to facilitate the capture of a segment of a media stream.

FIG. 2 is a block diagram illustrating an example multimedia device operable to facilitate the capture of a segment of a media stream.

FIG. 3 is a flowchart illustrating an example process operable to facilitate the capture of a segment of a media stream.

FIG. 4 is a flowchart illustrating an example process operable to facilitate the creation of a copy of a media stream segment, the copy including one or more parameters retrieved from the media stream.

FIG. 5 is a flowchart illustrating an example process operable to facilitate the creation of a copy of a media stream segment, the copy including one or more parameters retrieved from user input.

FIG. 6 is a block diagram of a hardware configuration operable to facilitate the capture of a segment of a media stream.

Like reference numbers and designations in the various drawings indicate like elements.

### DETAILED DESCRIPTION

It is desirable to provide methods and systems operable to facilitate an efficient capture of media segments. Methods, systems, and computer readable media may be operable to facilitate the capture of a segment of a media stream. A media segment may be captured from a media stream in response to a received media segment capture request. A media segment type may be determined from a default setting or from a received user command identifying the desired media segment type. Based on the determined media segment type, the captured media segment may be converted to a media format associated with the media segment type, and the converted media segment may be stored or output to an external sever or client device. Information associated with the media segment or media stream from which the media segment is captured may be retrieved from the media stream or user input and may be added to the converted media segment as metadata.

It should be understood that the methods, systems, and computer readable media described herein may work equally well with either in-home DVR or with network-based DVR (e.g., nDVR). Network DVR (nDVR) storage has the benefit of keeping these archived media segments in the cloud. In-home DVR may be supplemented with nDVR, thereby allowing these media segments to be moved to cloud storage. This enables permanent storage, even if the in-home DVR is replaced.

An embodiment of the invention described herein may include a method comprising: (a) receiving a request to capture a media segment of a media stream that is received at a multimedia device; (b) determining a media type associated with the media segment; (c) identifying from within the media stream, a start point for the media segment; (d) based on the determined media type associated with the media segment, determining a size of the media segment; (e) based on the identified start point for the media segment and determined size of the media segment, copying the media segment from the media stream; (f) identifying a media format associated with the media type that is associated with the media segment; (g) converting the copied media segment to the identified media format; and (h) storing the converted media segment.

According to an embodiment of the invention, the request to capture the media segment is received during playback of the media stream, and the start point comprises the playback position of the media stream as determined at the time at which the request is received.

According to an embodiment of the invention, the request to capture the media segment is received during playback of the media stream, the start point comprises a point in the media stream that is prior to the playback position of the media stream as determined at the time at which the request is received, and the start point is identified based upon an identified setback duration.

According to an embodiment of the invention, the identified setback duration comprises a duration of time that is received as input from a user.

According to an embodiment of the invention, the media type associated with the media segment is determined based upon an identification of the media type received by the multimedia device as user input.

According to an embodiment of the invention, the method described herein further comprises: (a) retrieving, from the media stream, one or more parameters associated with the media segment; and (b) adding the one or more parameters to the media segment as metadata.

According to an embodiment of the invention, the method described herein further comprises: (a) retrieving, from user input, one or more parameters associated with the media segment; and (b) adding the one or more parameters to the media segment as metadata.

An embodiment of the invention described herein may include an apparatus comprising: (a) an interface configured to be used to receive a request to capture a media segment of a media stream; (b) one or more modules configured to: (i) determine a media type associated with the media segment; (ii) identify from within the media stream, a start point for the media segment; (iii) based on the determined media type associated with the media segment, determine a size of the media segment; (iv) based on the identified start point for the media segment and determined size of the media segment, copy the media segment from the media stream; (v) identify a media format associated with the media type that is associated with the media segment; (vi) convert the copied media segment to the identified media format; and (vii) store the converted media segment.

According to an embodiment of the invention, the one or more modules are further configured to: (a) retrieve one or more parameters associated with the media segment; and (b) add the one or more parameters to the media segment as metadata.

An embodiment of the invention described herein may include one or more non-transitory computer readable media having instructions operable to cause one or more processors to perform the operations comprising: (a) receiving a request to capture a media segment of a media stream that is received at a multimedia device; (b) determining a media type associated with the media segment; (c) identifying from within the media stream, a start point for the media segment; (d) based on the determined media type associated with the media segment, determining a size of the media segment; (e) based on the identified start point for the media segment and determined size of the media segment, copying the media segment from the media stream; (f) identifying a media format associated with the media type that is associated with the media segment; (g) converting the copied media segment to the identified media format; and (h) storing the converted media segment.

According to an embodiment of the invention, the instructions are further operable to cause one or more processors to perform the operations comprising: (a) retrieving, from the media stream, one or more parameters associated with the media segment; and (b) adding the one or more parameters to the media segment as metadata.

According to an embodiment of the invention, the instructions are further operable to cause one or more processors to perform the operations comprising: (a) retrieving, from user input, one or more parameters associated with the media segment; and (b) adding the one or more parameters to the media segment as metadata.

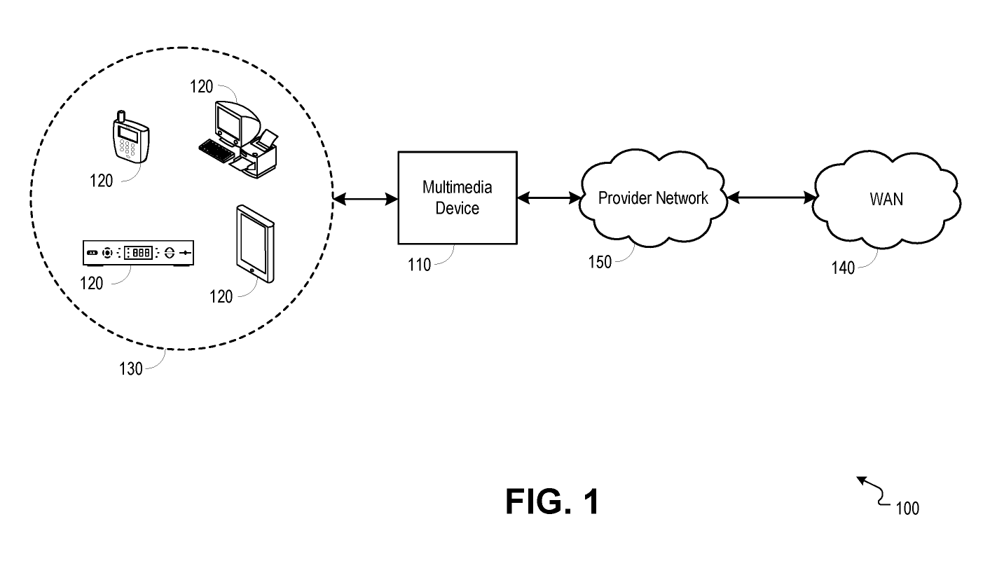

FIG. 1 is a block diagram illustrating an example network environment 100 operable to facilitate the capture of a segment of a media stream. In embodiments, a multimedia device 110 may be configured to provide multimedia services to one or more client devices 120. The multimedia device 110 may include a multimedia or residential gateway, a set-top box (STB), or any other device configured to receive, store, and/or deliver multimedia content to one or more client devices 120. Client devices 120 may include televisions, computers, tablets, mobile devices, STBs, game consoles, and any other device configured to receive a multimedia service.

In embodiments, multimedia content may be delivered from a multimedia device 110 to one or more client devices 120 over a local network 130 (e.g., a local area network (LAN), a wireless local area network (WLAN), a personal area network (PAN), etc.). The multimedia device 110 may receive services from and may communicate with an upstream wide area network (WAN) 140 through a connection to a provider network 150. It should be understood that the multimedia device 110 may operate as an access point to wirelessly deliver multimedia content to one or more client devices 120 that are associated with the multimedia device 110 as stations.

In embodiments, a multimedia device 110 may communicate with a client device 120 over a wired or a wireless connection. The multimedia device 110 may provide one or more channels or service sets through which services and communications may be delivered wirelessly to one or more client devices 120. A client device 120 may associate and authenticate with a multimedia device 110 or associated access point (e.g., wireless router, network extender, etc.), after which communications and services may be delivered from the multimedia device 110 to the client device 120. It should be understood that various protocols and/or standards (e.g., Wi-Fi, multimedia over coax alliance (MoCA), ZigBee etc.) may be used to deliver communications between a multimedia device 110 and client device 120.

A multimedia device 110 may output live or linear content to a client device 120 as the content is received at the multimedia device 110, or the multimedia device 110 may store content and output the stored content to a client device 120 at a later time. In embodiments, the multimedia device 110 may be configured to record and store one or more programs for later viewing by a user. During a subsequent playback of a recorded piece of content, the user may selectively edit and manage segments of the content for archiving.

In embodiments, trickplay controls (i.e., record, stop, fast-forward, reverse, etc.) associated with a multimedia device 110 or other display device (e.g., client device 120) may be used to create, edit, and/or manage segments of media content. For example, when content is being output to a display device and a predetermined button (e.g., a capture button or other button designated for initiating a media segment capture) is pressed at a control unit (e.g., remote control unit (RCU)) or a client device 120, then a segment of the media content may be captured and a copy of the segment may be created. For example, the media segment captured may be the media segment starting at the currently viewed point within the content.

In response to a received request to capture a segment of media that is being output by a multimedia device 110, the multimedia device 110 may identify the segment that is to be captured. For example, the multimedia device 110 may be configured to identify a single frame that is to be captured (i.e., the frame being output at the point at which the request was received) or may identify a plurality of frames or packets to be captured. The multimedia device 110 may be configured to identify a starting point within the media content, and it should be understood that the starting point may be identified based on the point at which the request was received, may be identified based on a default or user input setback duration (i.e., the starting point is the point in the content that is located a certain duration of time or number of frames prior to the point in the content at which the request was received), or may be identified using various other techniques.

In embodiments, a multimedia device 110 may be configured to record and store previously captured segments of content received at the multimedia device 110 in response to a request received from a user. During playback of content (e.g., linear or live content, recorded content, etc.) at a display device (e.g., display connected to the multimedia device 110 or client device 120 associated with the multimedia device 110), a user may initiate the capture of a media segment starting at a previously received point in the content. For example, during playback of a piece of content, the user may press a special remote key (e.g., a capture button or other button designated for initiating a media segment capture) to record a past scene or segment of the content, and in response, the user may be prompted to input a time period over which to capture the past scene or segment. The user may enter a period of time (e.g., four, five, six minutes, etc.) over which the user wants to record the past portion of content as a media segment of the content. Determination of the content segments for capture as a media segment may include a calculation of the past live off disk (LOD) buffer offset based on a user specified time, a current time, a content bitrate, and/or a total LOD buffer size.

In embodiments, the multimedia device 110 may be configured with a default setback duration which will be used as the amount of time by which the multimedia device 110 goes back from a current position to begin recording a media segment. Thus, a start point of the captured media segment may be identified without further instructions from a user as to a setback duration. In embodiments, the media segment may be copied from a LOD buffer used to temporarily store the received content, and the start point of the media segment may be identified from the LOD buffer.

In embodiments, the multimedia device 110 may capture an image, a video segment, an audio segment, or an audio/video segment of a media stream based upon a default setting or a user input received by the multimedia device 110. For example, the multimedia device 110 may be configured with a default setting to capture an image, a video segment, an audio segment, or an audio/video segment of a media stream when a media capture request is received. The multimedia device 110 may provide a user interface through which a user may control the various file formats for capturing and storing media segments. As another example, the media capture request may include an identification of a media type to be captured (e.g., image, video segment, audio segment, audio/video segment, etc.). The media segment may be abstracted from an active time shifting buffer or from a video decoder after the request for the media capture is received.

In embodiments, the multimedia device 110 may format and store the captured media segment based upon the media type captured. For example, an audio segment may be formatted and stored as an MPEG (moving picture experts group) 3 audio file or other audio format, an image may be formatted and stored as a JPEG (joint photographic experts group) file or other image format, and a video or audio/video segment may be formatted and stored as an MPEG file or other video format. It should be understood that a captured media segment may be formatted and stored as any standard file format by the multimedia device 110.

In embodiments, information associated with the media stream from which a media segment is captured may be retrieved from the media stream and stored along with the media segment as metadata. For example, information including, but not limited to, program name, channel name, chapter number, and other information associated with the media stream may be retrieved from the media stream and stored as metadata of the captured media segment. In embodiments, the multimedia device 110 may prompt a user for input of a unique identifier for a captured media segment. For example, the user may define a name for a media segment while initiating the capture of the media segment. As another example, the user may define a name for a media segment after the media segment is captured. In embodiments, the multimedia device 110 may be configured with a pre-defined naming convention. For example, a name may be automatically assigned by the multimedia device 110 to a media segment based upon a pre-defined convention (e.g., Scene1, Scene2 . . . etc.). The name or unique identifier given to a media segment may be stored as metadata of the media segment.

In embodiments, the multimedia device 110 may be configured to store one or more captured media segments. For example, the multimedia device 110 may locally store the media segments and may serve as a DLNA (digital living network alliance) digital media server. The multimedia device 110 may publish the availability of newly captured media segments. The multimedia device 110 may be configured to output captured media segments to an external or upstream server (e.g., hard drive, cloud server, etc.). It should be understood that the media segments may be accessed and utilized for a variety of purposes. For example, the media segments may be accessed by a user through a user interface (e.g., graphical user interface (GUI)) provided by the multimedia device 110, may be output to a user social media or messaging account, or may be used by a variety of other applications.

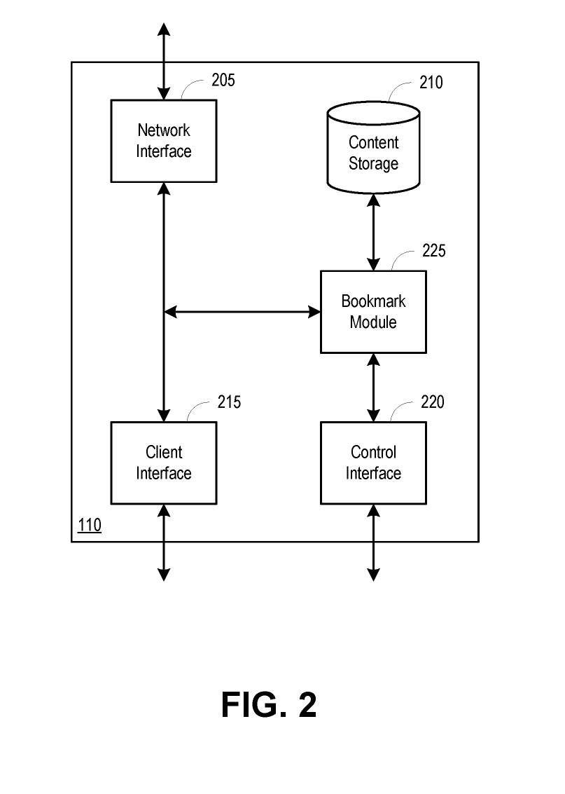

FIG. 2 is a block diagram illustrating an example multimedia device 110 operable to facilitate the capture of a segment of a media stream. The multimedia device 110 may include a network interface 205, content storage 210, a client interface 215, a control interface 220, and a bookmark module 225. The multimedia device 110 may include a multimedia or residential gateway, a set-top box (STB), or any other device configured to receive, store, and/or deliver multimedia content to one or more client devices 120 of FIG. 1.

In embodiments, the multimedia device 110 may communicate with one or more client devices 120 over a wired or a wireless connection through the client interface 215. The multimedia device 110 may output content and/or other services to client devices 120 through the client interface 215 and may receive requests for content and/or other upstream communications through the client interface 215. It should be understood that the client interface 215 may include various wired and/or wireless interfaces using various protocols and/or standards (e.g., Wi-Fi, multimedia over coax alliance (MoCA), ZigBee, Ethernet, etc.) to deliver communications between a multimedia device 110 and client device(s) 120. For example, the multimedia device 110 may communicate with one or more client devices 120 over a local network 130 of FIG. 1.

In embodiments, content may be received at the multimedia device 110 from an upstream network (e.g., provider network 150 of FIG. 1, WAN 140 of FIG. 1, etc.) through the network interface 205. Communications and services received through the network interface 205 may be forwarded to one or more client devices 120 through the client interface 215. For example, content streams (e.g., live or linear content, VoD content, recorded content, etc.) may be recorded by the multimedia device 110 and stored at content storage 210, and/or the content streams may be forwarded to one or more client devices 120 through the client interface 215. The multimedia device 110 may include one or more live off disk (LOD) buffers (e.g., at content storage 210), and content streams received at the multimedia device 110 may be temporarily stored or buffered within the LOD buffer(s).

In embodiments, the output of content (e.g., both recorded and linear content) may be controlled by user requests received from a control device (e.g., RCU) through the control interface 220. For example, a user may view available content through a menu displayed at a display device, and may select content for delivery from the multimedia device 110 to a client device 120. The user may control playback and recording functions at the multimedia device 110 using various buttons at a control device (e.g., record, play, fast-forward, rewind, skip, and other trickplay controls).

In embodiments, one or more commands or requests for initiating a capture of a media segment may be received through the control interface 220 or client interface 215. For example, when content is being output to a display device and a predetermined button (e.g., a capture button or other button designated for initiating a media segment capture) is pressed at a control unit (e.g., remote control unit (RCU)) or a client device 120, then a segment of the media content may be captured and a copy of the segment may be created. For example, the media segment captured may be the media segment starting at the currently viewed point within the content.

In response to a received request to capture a segment of media that is being output by a multimedia device 110, the bookmark module 225 may identify the segment that is to be captured. For example, the bookmark module 225 may be configured to identify a single frame that is to be captured (i.e., the frame being output at the point at which the request was received) or may identify a plurality of frames or packets to be captured. The bookmark module 225 may be configured to identify a starting point within the media content, and it should be understood that the starting point may be identified based on the point at which the request was received, may be identified based on a default or user input setback duration (i.e., the starting point is the point in the content that is located a certain duration of time or number of frames prior to the point in the content at which the request was received), or may be identified using various other techniques.

In embodiments, the bookmark module 225 may be configured to identify a start point for a captured media segment based upon a received user input identifying a time period over which to capture the past scene or segment. The user may enter a period of time (e.g., four, five, six minutes, etc.) over which the user wants to record the past portion of content as a media segment of the content. Determination of the content segments for capture as a media segment may include a calculation of the past live off disk (LOD) buffer offset based on a user specified time, a current time, a content bitrate, and/or a total LOD buffer size.

In embodiments, the bookmark module 225 may be configured with a default setback duration which will be used as the amount of time by which the bookmark module 225 goes back from a current position to begin recording a media segment. Thus, a start point of the captured media segment may be identified without further instructions from a user as to a setback duration. In embodiments, the media segment may be copied from a LOD buffer used to temporarily store the received content, and the start point of the media segment may be identified from the LOD buffer.

In embodiments, the bookmark module 225 may capture an image, a video segment, an audio segment, or an audio/video segment of a media stream based upon a default setting or a user input received by the bookmark module 225. For example, the bookmark module 225 may be configured with a default setting to capture an image, a video segment, an audio segment, or an audio/video segment of a media stream when a media capture request is received. The bookmark module 225 may provide a user interface through which a user may control the various file formats for capturing and storing media segments. As another example, the media capture request may include an identification of a media type to be captured (e.g., image, video segment, audio segment, audio/video segment, etc.). The media segment may be abstracted from an active time shifting buffer or from a video decoder after the request for the media capture is received.

In embodiments, the bookmark module 225 may format and store the captured media segment based upon the media type captured. For example, an audio segment may be formatted and stored as an MPEG (moving picture experts group) 3 audio file or other audio format, an image may be formatted and stored as a JPEG (joint photographic experts group) file or other image format, and a video or audio/video segment may be formatted and stored as an MPEG file or other video format. It should be understood that a captured media segment may be formatted and stored as any standard file format.

In embodiments, the bookmark module 225 may retrieve information associated with the media stream from which a media segment is captured or the media segment itself, and the bookmark module 225 may store the retrieved information as metadata of the media segment. For example, information including, but not limited to, program name, channel name, chapter number, and other information associated with the media stream may be retrieved from the media stream and stored as metadata of the captured media segment. In embodiments, the bookmark module 225 may output a prompt for user input of a unique identifier for a captured media segment. In embodiments, the bookmark module 225 may be configured with a pre-defined naming convention. For example, a name may be automatically assigned by the bookmark module 225 to a media segment based upon a pre-defined convention (e.g., Scene1, Scene2 . . . etc.). The name or unique identifier given to a media segment may be stored as metadata of the media segment.

In embodiments, the bookmark module 225 may be configured to store one or more captured media segments within content storage 210. The bookmark module 225 may be configured to output captured media segments to an external or upstream server (e.g., hard drive, cloud server, etc.). It should be understood that the media segments may be accessed and utilized for a variety of purposes. For example, the media segments may be accessed by a user through a user interface (e.g., graphical user interface (GUI)) provided by the bookmark module 225, may be output to a user social media or messaging account, or may be used by a variety of other applications.

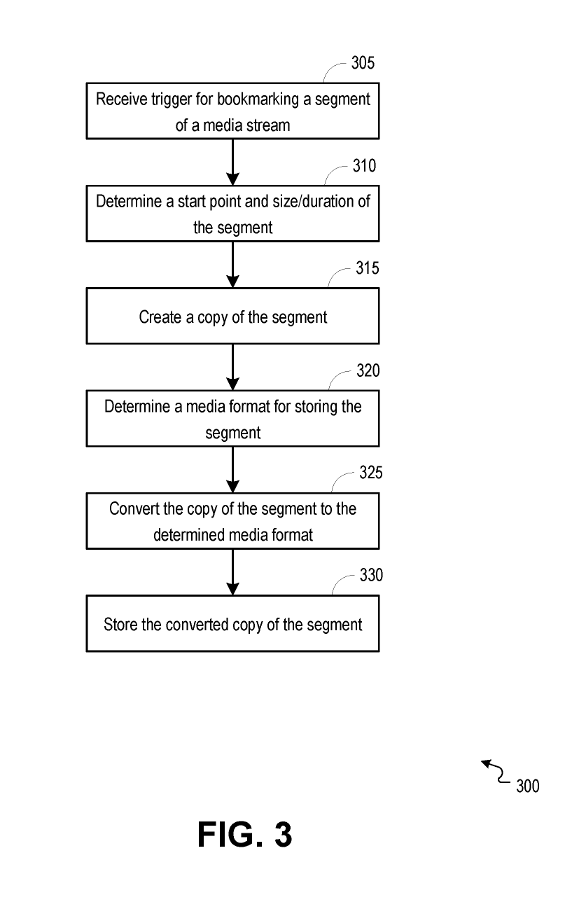

FIG. 3 is a flowchart illustrating an example process 300 operable to facilitate the capture of a segment of a media stream. The process 300 may begin at 305 when a trigger for bookmarking a segment of a media stream is received. The trigger for bookmarking a segment of a media stream may be received by a multimedia device 110 of FIG. 1. In embodiments, the trigger for bookmarking a segment of a media stream may include a command or request for the capture of a media segment that is received at a multimedia device 110 from an RCU or client device 120 of FIG. 1. For example, while outputting a piece of content to a device, the multimedia device 110 (e.g., the bookmark module 225) may recognize a predetermined command (e.g., a capture button or other button designated for initiating a media segment capture) as a request to bookmark a media segment.

At 310, a start point and size/duration of the segment may be determined. The start point and size/duration of the segment may be determined, for example, by the bookmark module 225 of FIG. 2. In embodiments, the start point of the segment may be the point within the piece of content being output by the multimedia device 110 when the request for initiation of the media segment capture is received or recognized by the multimedia device 110. For example, the bookmark module 225 may be configured to identify a current frame (e.g., a current read position within the recorded piece of content, a frame displayed at a display device when the bookmark trigger is received, a current frame in an output buffer, a current frame in a LOD buffer, etc.) as the start point of the segment. In embodiments, the bookmark module 225 may be configured with a setback duration (e.g., a duration of time or number of frames or packets), wherein a frame positioned away from (i.e., before or after) the current frame by the setback duration in the media stream is identified as the start point of the segment.

In embodiments, the size/duration of the segment may be determined based upon the type of media segment that is to be captured. The media segment type may include an image, a video segment, an audio segment, an audio/video segment, or other type. The media segment type may be based upon an identification of the media segment type received by a user (e.g., identification carried by the bookmarking trigger) or may be based upon a default setting at the multimedia device 110. It should be understood that the media type may be determined in other ways as well. The duration of the segment may be determined based upon the media type, a default setting, and/or user input of a duration. For example, when the media type is an image, the bookmark module 225 may determine that the duration of the media segment is a single or group of individual frames or packets. When the media type is an audio segment, a video segment, or an audio/video segment, the duration of the media segment may be a plurality of consecutive frames or packets, and the number of frames or packets captured may be based on a default setting (e.g., 5, 10, 30 seconds for an audio, video, or audio/video segment) or a user input (e.g., user input of a certain duration of the media segment to be captured).

At 315, a copy of the media segment may be created. The copy of the media segment may be created, for example, by the bookmark module 225. In embodiments, the bookmark module 225 may identify the portion of the media stream for copying based on the determined start point and size/duration of the segment (i.e., the start point and size/duration of the segment as determined at 310). For example, the bookmark module 225 may copy the portion of the media stream starting at the determined start point and ending at a point within the media stream that is located apart from the start point by the determined size/duration. In embodiments, the bookmark module 225 may copy the media segment from a buffer, decoder, or other module of the multimedia device 110 serving to temporarily store the portion of the media stream making up the media segment. For example, the media segment may be abstracted from an active time shifting buffer or from a video decoder of the multimedia device 110.

At 320, a media format for storing the media segment may be determined. The media format may be determined, for example, by the bookmark module 225. In embodiments, the bookmark module 225 may determine the media format for storing the media segment based upon an identified media segment type associated with the media segment. For example, the media type of the media segment may be identified as an image, a video segment, an audio segment, or an audio/video segment of a media stream based upon a default setting or a user input (e.g., the media capture request may include an identification of a media type to be captured) received by the bookmark module 225. The bookmark module 225 may determine the media format for storing the media segment based upon the media type captured. For example, an audio segment may be formatted and stored as an MPEG (moving picture experts group) 3 audio file or other audio format, an image may be formatted and stored as a JPEG (joint photographic experts group) file or other image format, and a video or audio/video segment may be formatted and stored as an MPEG file or other video format. It should be understood that a captured media segment may be formatted and stored as any standard file format.

At 325, the copy of the media segment may be converted to the determined media format, and the converted copy of the media segment may be stored at 330. The copy of the media segment may be converted to the determined media format, for example, by the bookmark module 225. The converted copy of the media segment may be stored at the multimedia device 110 (e.g., at the content storage 210 of FIG. 2), or the converted copy of the media segment may be output to an external or upstream server or device (e.g., a client device 120 of FIG. 2).

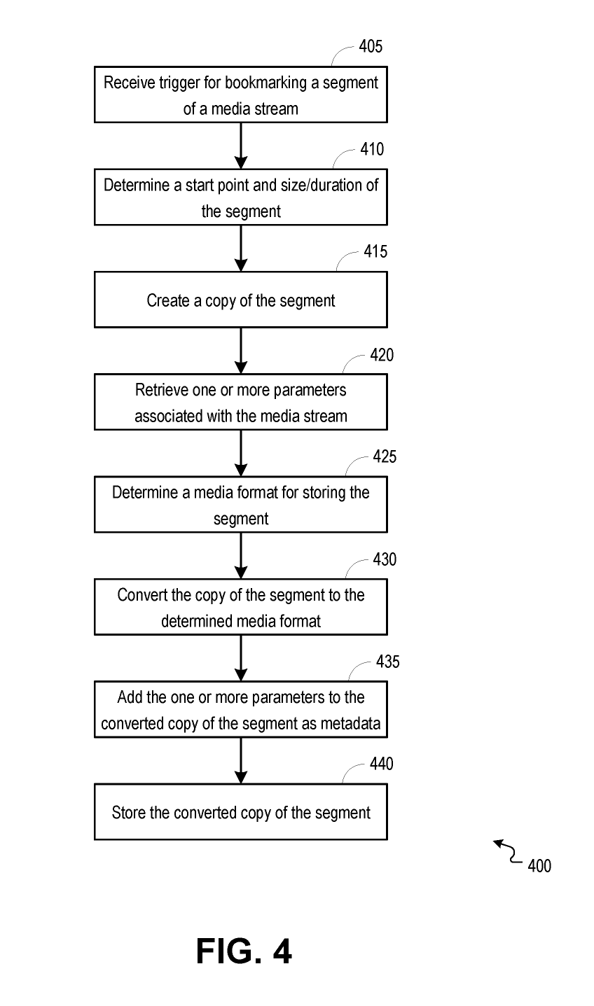

FIG. 4 is a flowchart illustrating an example process 400 operable to facilitate the creation of a copy of a media stream segment, the copy including one or more parameters retrieved from the media stream. The process 400 may begin at 405 when a trigger for bookmarking a segment of a media stream is received. The trigger for bookmarking a segment of a media stream may be received by a multimedia device 110 of FIG. 1. In embodiments, the trigger for bookmarking a segment of a media stream may include a command or request for the capture of a media segment that is received at a multimedia device 110 from an RCU or client device 120 of FIG. 1. For example, while outputting a piece of content to a device, the multimedia device 110 (e.g., the bookmark module 225) may recognize a predetermined command (e.g., a capture button or other button designated for initiating a media segment capture) as a request to bookmark a media segment.

At 410, a start point and size/duration of the segment may be determined. The start point and size/duration of the segment may be determined, for example, by the bookmark module 225 of FIG. 2. In embodiments, the start point of the segment may be the point within the piece of content being output by the multimedia device 110 when the request for initiation of the media segment capture is received or recognized by the multimedia device 110. For example, the bookmark module 225 may be configured to identify a current frame (e.g., a current read position within the recorded piece of content, a frame displayed at a display device when the bookmark trigger is received, a current frame in an output buffer, a current frame in a LOD buffer, etc.) as the start point of the segment. In embodiments, the bookmark module 225 may be configured with a setback duration (e.g., a duration of time or number of frames or packets), wherein a frame positioned away from (i.e., before or after) the current frame by the setback duration in the media stream is identified as the start point of the segment.

In embodiments, the size/duration of the segment may be determined based upon the type of media segment that is to be captured. The media segment type may include an image, a video segment, an audio segment, an audio/video segment, or other type. The media segment type may be based upon an identification of the media segment type received by a user (e.g., identification carried by the bookmarking trigger) or may be based upon a default setting at the multimedia device 110. It should be understood that the media type may be determined in other ways as well. The duration of the segment may be determined based upon the media type, a default setting, and/or user input of a duration. For example, when the media type is an image, the bookmark module 225 may determine that the duration of the media segment is a single or group of individual frames or packets. When the media type is an audio segment, a video segment, or an audio/video segment, the duration of the media segment may be a plurality of consecutive frames or packets, and the number of frames or packets captured may be based on a default setting (e.g., 5, 10, 30 seconds for an audio, video, or audio/video segment) or a user input (e.g., user input of a certain duration of the media segment to be captured).

At 415, a copy of the media segment may be created. The copy of the media segment may be created, for example, by the bookmark module 225. In embodiments, the bookmark module 225 may identify the portion of the media stream for copying based on the determined start point and size/duration of the segment (i.e., the start point and size/duration of the segment as determined at 410). For example, the bookmark module 225 may copy the portion of the media stream starting at the determined start point and ending at a point within the media stream that is located apart from the start point by the determined size/duration. In embodiments, the bookmark module 225 may copy the media segment from a buffer, decoder, or other module of the multimedia device 110 serving to temporarily store the portion of the media stream making up the media segment. For example, the media segment may be abstracted from an active time shifting buffer or from a video decoder of the multimedia device 110.

At 420, one or more parameters associated with the media stream may be retrieved. The one or more parameters may be retrieved, for example, by the bookmark module 225. In embodiments, the bookmark module 225 may retrieve parameters associated with the media stream from which the media segment is captured, and the parameters may include information such as program name, channel name, chapter number, and other information associated with the media stream. The one or more parameters may be retrieved from metadata of the media stream, from EPG (electronic program guide) data associated with the media stream, or from another source.

At 425, a media format for storing the media segment may be determined. The media format may be determined, for example, by the bookmark module 225. In embodiments, the bookmark module 225 may determine the media format for storing the media segment based upon an identified media segment type associated with the media segment. For example, the media type of the media segment may be identified as an image, a video segment, an audio segment, or an audio/video segment of a media stream based upon a default setting or a user input (e.g., the media capture request may include an identification of a media type to be captured) received by the bookmark module 225. The bookmark module 225 may determine the media format for storing the media segment based upon the media type captured. For example, an audio segment may be formatted and stored as an MPEG (moving picture experts group) 3 audio file or other audio format, an image may be formatted and stored as a JPEG (joint photographic experts group) file or other image format, and a video or audio/video segment may be formatted and stored as an MPEG file or other video format. It should be understood that a captured media segment may be formatted and stored as any standard file format.

At 430, the copy of the media segment may be converted to the determined media format. The copy of the media segment may be converted to the determined media format, for example, by the bookmark module 225.

At 435, the one or more parameters may be added to the converted copy of the segment as metadata. The parameters may be added to the converted copy of the segment as metadata, for example, by the bookmark module 225.

At 440, the converted copy of the segment may be stored. The converted copy of the media segment may be stored at the multimedia device 110 (e.g., at the content storage 210 of FIG. 2), or the converted copy of the media segment may be output to an external or upstream server or device (e.g., a client device 120 of FIG. 2).

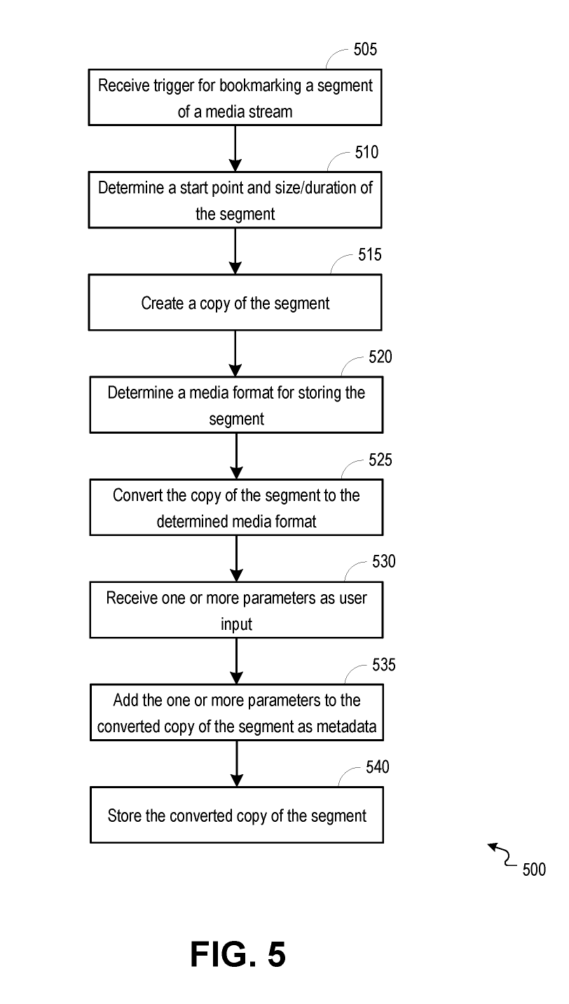

FIG. 5 is a flowchart illustrating an example process 500 operable to facilitate the creation of a copy of a media stream segment, the copy including one or more parameters retrieved from user input. The process 500 may begin at 505 when a trigger for bookmarking a segment of a media stream is received. The trigger for bookmarking a segment of a media stream may be received by a multimedia device 110 of FIG. 1. In embodiments, the trigger for bookmarking a segment of a media stream may include a command or request for the capture of a media segment that is received at a multimedia device 110 from an RCU or client device 120 of FIG. 1. For example, while outputting a piece of content to a device, the multimedia device 110 (e.g., the bookmark module 225) may recognize a predetermined command (e.g., a capture button or other button designated for initiating a media segment capture) as a request to bookmark a media segment.

At 510, a start point and size/duration of the segment may be determined. The start point and size/duration of the segment may be determined, for example, by the bookmark module 225 of FIG. 2. In embodiments, the start point of the segment may be the point within the piece of content being output by the multimedia device 110 when the request for initiation of the media segment capture is received or recognized by the multimedia device 110. For example, the bookmark module 225 may be configured to identify a current frame (e.g., a current read position within the recorded piece of content, a frame displayed at a display device when the bookmark trigger is received, a current frame in an output buffer, a current frame in a LOD buffer, etc.) as the start point of the segment. In embodiments, the bookmark module 225 may be configured with a setback duration (e.g., a duration of time or number of frames or packets), wherein a frame positioned away from (i.e., before or after) the current frame by the setback duration in the media stream is identified as the start point of the segment.

In embodiments, the size/duration of the segment may be determined based upon the type of media segment that is to be captured. The media segment type may include an image, a video segment, an audio segment, an audio/video segment, or other type. The media segment type may be based upon an identification of the media segment type received by a user (e.g., identification carried by the bookmarking trigger) or may be based upon a default setting at the multimedia device 110. It should be understood that the media type may be determined in other ways as well. The duration of the segment may be determined based upon the media type, a default setting, and/or user input of a duration. For example, when the media type is an image, the bookmark module 225 may determine that the duration of the media segment is a single or group of individual frames or packets. When the media type is an audio segment, a video segment, or an audio/video segment, the duration of the media segment may be a plurality of consecutive frames or packets, and the number of frames or packets captured may be based on a default setting (e.g., 5, 10, 30 seconds for an audio, video, or audio/video segment) or a user input (e.g., user input of a certain duration of the media segment to be captured).

At 515, a copy of the media segment may be created. The copy of the media segment may be created, for example, by the bookmark module 225. In embodiments, the bookmark module 225 may identify the portion of the media stream for copying based on the determined start point and size/duration of the segment (i.e., the start point and size/duration of the segment as determined at 510). For example, the bookmark module 225 may copy the portion of the media stream starting at the determined start point and ending at a point within the media stream that is located apart from the start point by the determined size/duration. In embodiments, the bookmark module 225 may copy the media segment from a buffer, decoder, or other module of the multimedia device 110 serving to temporarily store the portion of the media stream making up the media segment. For example, the media segment may be abstracted from an active time shifting buffer or from a video decoder of the multimedia device 110.

At 520, a media format for storing the media segment may be determined. The media format may be determined, for example, by the bookmark module 225. In embodiments, the bookmark module 225 may determine the media format for storing the media segment based upon an identified media segment type associated with the media segment. For example, the media type of the media segment may be identified as an image, a video segment, an audio segment, or an audio/video segment of a media stream based upon a default setting or a user input (e.g., the media capture request may include an identification of a media type to be captured) received by the bookmark module 225. The bookmark module 225 may determine the media format for storing the media segment based upon the media type captured. For example, an audio segment may be formatted and stored as an MPEG (moving picture experts group) 3 audio file or other audio format, an image may be formatted and stored as a JPEG (joint photographic experts group) file or other image format, and a video or audio/video segment may be formatted and stored as an MPEG file or other video format. It should be understood that a captured media segment may be formatted and stored as any standard file format.

At 525, the copy of the media segment may be converted to the determined media format. The copy of the media segment may be converted to the determined media format, for example, by the bookmark module 225.

At 530, one or more parameters associated with the media segment may be received as a user input. The one or more parameters may be received, for example, by the bookmark module 225. In embodiments, the bookmark module 225 may receive the one or more parameters from a message serving as the media segment capture trigger or may receive the one or more parameters from a message input by a user in response to a prompt requesting information associated with the media segment. For example, the one or more parameters associated with the media segment may include a unique identifier (e.g., a name) associated with the media segment.

At 535, the one or more parameters may be added to the converted copy of the segment as metadata. The parameters may be added to the converted copy of the segment as metadata, for example, by the bookmark module 225.

At 540, the converted copy of the segment may be stored. The converted copy of the media segment may be stored at the multimedia device 110 (e.g., at the content storage 210 of FIG. 2), or the converted copy of the media segment may be output to an external or upstream server or device (e.g., a client device 120 of FIG. 2).

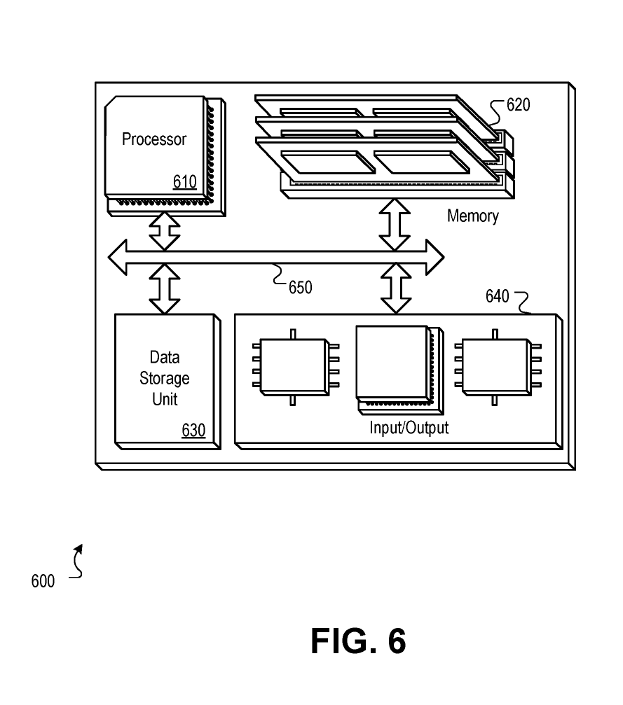

FIG. 6 is a block diagram of a hardware configuration 600 operable to facilitate the capture of a segment of a media stream. The hardware configuration 600 can include a processor 610, a memory 620, a storage device 630, and an input/output device 640. Each of the components 610, 620, 630, and 640 can, for example, be interconnected using a system bus 650. The processor 610 can be capable of processing instructions for execution within the hardware configuration 600. In one implementation, the processor 610 can be a single-threaded processor. In another implementation, the processor 610 can be a multi-threaded processor. The processor 610 can be capable of processing instructions stored in the memory 620 or on the storage device 630.

The memory 620 can store information within the hardware configuration 600. In one implementation, the memory 620 can be a computer-readable medium. In one implementation, the memory 620 can be a volatile memory unit. In another implementation, the memory 620 can be a non-volatile memory unit.

In some implementations, the storage device 630 can be capable of providing mass storage for the hardware configuration 600. In one implementation, the storage device 630 can be a computer-readable medium. In various different implementations, the storage device 630 can, for example, include a hard disk device, an optical disk device, flash memory or some other large capacity storage device. In other implementations, the storage device 630 can be a device external to the hardware configuration 600.

The input/output device 640 provides input/output operations for the hardware configuration 600. In one implementation, the input/output device 640 can include one or more of a network interface device (e.g., an Ethernet card), a serial communication device (e.g., an RS-232 port), one or more universal serial bus (USB) interfaces (e.g., a USB 2.0 port), one or more wireless interface devices (e.g., an 802.11 card), and/or one or more interfaces for outputting video and/or data services to a central or access device (e.g., multimedia device 110 of FIG. 1 such as an access point, gateway device, STB, DVR or other content storage device, cable modem, router, wireless extender, or other access device) or client device 120 of FIG. 1 (e.g., STB, computer, television, tablet, mobile device, etc.). In another implementation, the input/output device can include driver devices configured to send communications to, and receive communications from one or more networks (e.g., WAN 140 of FIG. 1, local network 130 of FIG. 1, provider network 150 of FIG. 1, etc.).

Those skilled in the art will appreciate that the invention described herein improves upon methods and systems for capturing media segments. Methods, systems, and computer readable media may be operable to facilitate the capture of a segment of a media stream. A media segment may be captured from a media stream in response to a received media segment capture request. A media segment type may be determined from a default setting or from a received user command identifying the desired media segment type. Based on the determined media segment type, the captured media segment may be converted to a media format associated with the media segment type, and the converted media segment may be stored or output to an external sever or client device. Information associated with the media segment or media stream from which the media segment is captured may be retrieved from the media stream or user input and may be added to the converted media segment as metadata.

The subject matter of this disclosure, and components thereof, can be realized by instructions that upon execution cause one or more processing devices to carry out the processes and functions described above. Such instructions can, for example, comprise interpreted instructions, such as script instructions, e.g., JavaScript or ECMAScript instructions, or executable code, or other instructions stored in a computer readable medium.

Implementations of the subject matter and the functional operations described in this specification can be provided in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification are performed by one or more programmable processors executing one or more computer programs to perform functions by operating on input data and generating output thereby tying the process to a particular machine (e.g., a machine programmed to perform the processes described herein). The processes and logic flows can also be performed by, and apparatus can also be implemented as, special purpose logic circuitry, e.g., an FPGA (field programmable gate array) or an ASIC (application specific integrated circuit).

Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD ROM disks. The processor and the memory can be supplemented by, or incorporated in, special purpose logic circuitry.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results, unless expressly noted otherwise. As one example, the processes depicted in the accompanying figures do not necessarily require the particular order shown, or sequential order, to achieve desirable results. In some implementations, multitasking and parallel processing may be advantageous.

We claim:

1. A method comprising:
receiving a request to capture a media segment of a media stream that is received at a multimedia device;
determining a media type associated with the media segment;
identifying from within the media stream, a start point for the media segment;
based on the determined media type associated with the media segment, determining a size of the media segment;
based on the identified start point for the media segment and determined size of the media segment, copying the media segment from the media stream;
identifying a media format associated with the media type that is associated with the media segment;
converting the copied media segment to the identified media format; and
storing the converted media segment.

2. The method of claim 1, wherein:
the request to capture the media segment is received during playback of the media stream; and
the start point comprises the playback position of the media stream as determined at the time at which the request is received.

3. The method of claim 1, wherein:
the request to capture the media segment is received during playback of the media stream;
the start point comprises a point in the media stream that is prior to the playback position of the media stream as determined at the time at which the request is received; and
the start point is identified based upon an identified setback duration.

4. The method of claim 3, wherein the identified setback duration comprises a duration of time that is received as input from a user.

5. The method of claim 1, wherein the media type associated with the media segment is determined based upon an identification of the media type received by the multimedia device as user input.

6. The method of claim 1, further comprising:
retrieving, from the media stream, one or more parameters associated with the media segment; and
adding the one or more parameters to the media segment as metadata.

7. The method of claim 1, further comprising:
retrieving, from user input, one or more parameters associated with the media segment; and
adding the one or more parameters to the media segment as metadata.

8. An apparatus comprising:
an interface configured to be used to receive a request to capture a media segment of a media stream;
one or more modules configured to:
determine a media type associated with the media segment;
identify from within the media stream, a start point for the media segment;
based on the determined media type associated with the media segment, determine a size of the media segment;
based on the identified start point for the media segment and determined size of the media segment, copy the media segment from the media stream;
identify a media format associated with the media type that is associated with the media segment;
convert the copied media segment to the identified media format; and
store the converted media segment.

9. The apparatus of claim 8, wherein:
the request to capture the media segment is received during playback of the media stream; and
the start point comprises the playback position of the media stream as determined at the time at which the request is received.

10. The apparatus of claim 8, wherein:
the request to capture the media segment is received during playback of the media stream;
the start point comprises a point in the media stream that is prior to the playback position of the media stream as determined at the time at which the request is received; and
the start point is identified based upon an identified setback duration.

11. The apparatus of claim 10, wherein the identified setback duration comprises a duration of time that is received as input from a user.

12. The apparatus of claim 8, wherein the media type associated with the media segment is determined based upon a user input identifying the media type.

13. The apparatus of claim 8, wherein the one or more modules are further configured to:
retrieve one or more parameters associated with the media segment; and
add the one or more parameters to the media segment as metadata.

14. One or more non-transitory computer readable media having instructions operable to cause one or more processors to perform the operations comprising:
receiving a request to capture a media segment of a media stream that is received at a multimedia device;
determining a media type associated with the media segment;
identifying from within the media stream, a start point for the media segment;
based on the determined media type associated with the media segment, determining a size of the media segment;
based on the identified start point for the media segment and determined size of the media segment, copying the media segment from the media stream;
identifying a media format associated with the media type that is associated with the media segment;
converting the copied media segment to the identified media format; and
storing the converted media segment.

15. The one or more non-transitory computer-readable media of claim 14, wherein:
the request to capture the media segment is received during playback of the media stream; and
the start point comprises the playback position of the media stream as determined at the time at which the request is received.

16. The one or more non-transitory computer-readable media of claim 14, wherein:
the request to capture the media segment is received during playback of the media stream;
the start point comprises a point in the media stream that is prior to the playback position of the media stream as determined at the time at which the request is received; and
the start point is identified based upon an identified setback duration.

17. The one or more non-transitory computer-readable media of claim 16, wherein the identified setback duration comprises a duration of time that is received as input from a user.

18. The one or more non-transitory computer-readable media of claim 14, wherein the media type associated with the media segment is determined based upon an identification of the media type received by the multimedia device as user input.

19. The one or more non-transitory computer-readable media of claim 14, wherein the instructions are further operable to cause one or more processors to perform the operations comprising:
retrieving, from the media stream, one or more parameters associated with the media segment; and
adding the one or more parameters to the media segment as metadata.

20. The one or more non-transitory computer-readable media of claim 14, wherein the instructions are further operable to cause one or more processors to perform the operations comprising:
retrieving, from user input, one or more parameters associated with the media segment; and
adding the one or more parameters to the media segment as metadata.
